(19) United States
(12) Patent Application Publication
(10) Pub. No.: US 2005/0115932 A1
(43) Pub. Date: Jun. 2, 2005

(54) Method of improving the service life of a plasma torch electrode

(76) Inventors: David Edward Deegan, Gloucestershire (GB); Chris David Chapman, Gloucestershire (GB); Timothy Paul Johnson, Gloucestershire (GB)

Correspondence Address: MORRIS, MANNING & MARTIN LLP, 6000 FAIRVIEW ROAD, SUITE 1125, CHARLOTTE, NC, 28210, US

(21) Appl. No.: 10/332,638

(22) PCT Filed: Jul. 10, 2001
(86) PCT No.: PCT/GB01/03093

(30) Foreign Application Priority Data
Jul. 10, 2000 (GB) 0016923.5

(51) Int. Cl. B23K 10/00; B23K 15/06

(52) U.S. Cl. 219/121.52; 219/121.14

(57) ABSTRACT

The present invention relates to plasma torches and, in particular, to a method of improving the service life of electrodes, especially stub-ended electrodes. An electrode for a plasma torch comprises an electrode body and an electrode tip, wherein the electrode tip is fusion welded either directly or indirectly to the electrode body.

The present invention relates to plasma torches and, in particular, to a method of improving the service life of electrodes, especially stub-ended electrodes.

A plasma torch will typically comprise an anode electrode or a cathode electrode. The electrode comprises an electrode tip portion which, in use, may oppose the electrode tip portion of another electrode of opposite charge. On application of a voltage across the electrode tips, a plasma arc can be generated in the space therebetween. In a twin plasma torch apparatus, the two torches are oppositely charged, i.e. one has an anode electrode and the other a cathode electrode. In such an apparatus, the arcs generated by each electrode are coupled together in a coupling zone remote from the two torches. Plasma gases may be passed through each torch and are ionised to form a plasma which concentrates in the coupling zone, away from torch interference. The material to be heated/melted is directed into this coupling zone wherein the thermal energy in the plasma is transferred to the material. Twin plasma processing can occur in open or confined processing zones. Twin plasma apparatus are often used in furnace applications and have been the subject of previous patent applications, for example EP 0 398 699 and U.S. Pat. No. 5,256,855.

Stub-ended electrodes may be used to act as the anode electrode in a plasma torch assembly, for example a twin torch assembly. The stub end acts as the electrode tip and may be made of, for example, copper, silver or alloys thereof and is mounted on the electrode body. The electrode body is also formed from a metal or alloy and, in use, there is therefore an electrical contact between it and the stub end.

It has been found that the service life of a stub-ended electrode may be predicted by assessing the distortion of the front face of the tip, which is thought to reduce the effectiveness of the cooling.

Conventional manufacture of a stub-ended electrode involves soldering the front face attachment to either the electrode body or a tip holder portion thereof.

The inventors have found that by fusion welding, for example electron beam welding, the mating surfaces together surface distortion on the front face of the stub end can been reduced with the corollary of a service life prediction improvement of up to ten times compared with the prior art electrodes.

Accordingly, the present invention provides an electrode for a plasma torch comprising an electrode body and an electrode tip, wherein the electrode tip is fusion welded either directly or indirectly to the electrode body.

The electrode tip is preferably electron beam welded either directly or indirectly to the electrode body, although it may also be laser welded.

Electron beam welding is a fusion welding technique which involves heating the metal components by a concentrated focussed beam of electrons, preferably in vacuo. The metal components themselves are melted locally at the joint without the use of a filler metal. This is in contrast to the conventional soldering and brazing techniques.

Typically, the electrode will comprise a body having an electrode tip holder portion, wherein the electrode tip is fusion welded to the electrode tip holder portion. The body may comprise a metal housing, wherein the electrode tip holder portion is mounted on the metal housing. It will be appreciated that there is electrical contact between the housing, the tip holder and the electrode tip.

In a preferred embodiment, the electrode tip is a stub-ended tip. Such a tip may take the form of a cap with a substantially planar front face, from where the plasma is generated. The tip may be dimensioned to be mounted on the electrode body or tip holder portion thereof and secured in place by fusion welding, preferably electron beam welding.

The electrode tip will generally be formed from a metallic material such as, copper, tungsten or silver, including alloys of one or more thereof. Examples of alloys include copper-silver, tungsten-copper, tungsten-silver and tungsten-copper-silver. Other elements may also be included.

The electrode may advantageously be used as an anode electrode.

The present invention also provides a plasma torch having an electrode as herein described.

The present invention also provides a plasma twin torch assembly comprising an anode electrode as herein described and a cathode electrode.

In a second aspect of the present invention, there is provided a process for the manufacture of an electrode for a plasma torch comprising an electrode body and an electrode tip, which process comprises the step of fusion welding the electrode tip, either directly or indirectly, to the electrode body.

The step of fusion welding is preferably electron beam welding and is preferably performed in vacuo.

In a third aspect of the present invention, there is provided a method of improving the service life of an electrode comprising an electrode body and an electrode tip, which method comprises joining, either directly or indirectly, the electrode tip to the electrode body by fusion welding, preferably electron beam welding. The electrode is advantageously an anode electrode and preferably has a stub-ended electrode tip.

The method of the present invention is particularly applicable to improving the service life of anode electrodes, particularly anode electrodes used for applications requiring current levels of approximately 3000 A or above.

The present invention will now be described further, by way of example, with reference to the following figures in which:

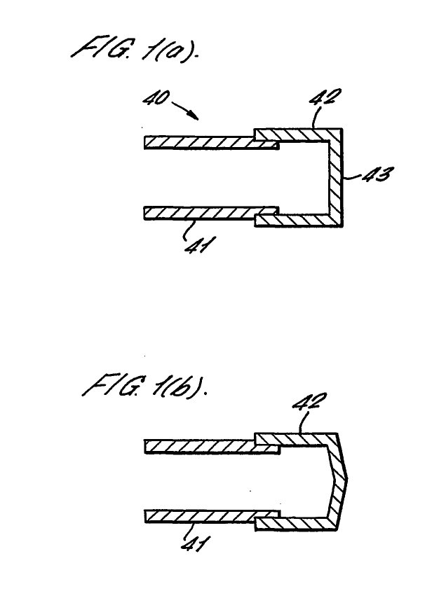

FIG. 1(a) is a schematic illustration of a stub-ended electrode tip mounted on an electrode tip holder;

FIG. 1(b) schematically illustrates the distortion of the front face of the stub end which occurs in use;

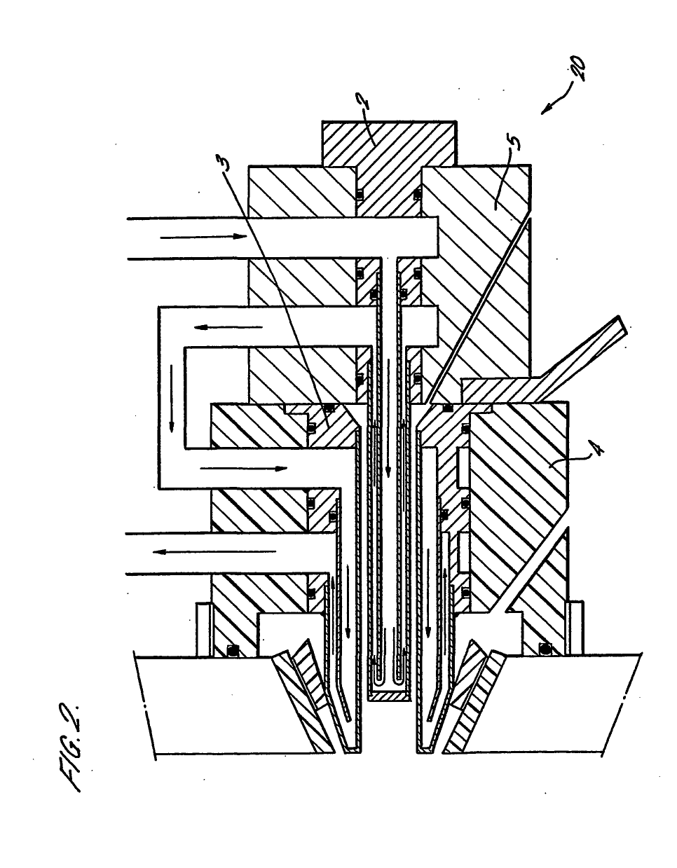

FIG. 2 is a cross section of an anode torch assembly;

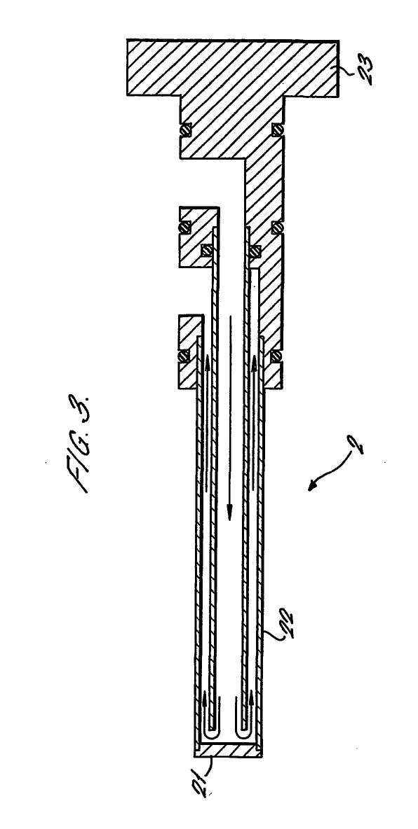

FIG. 3 is a cross section of an anode electrode module of the torch assembly of FIG. 2; and

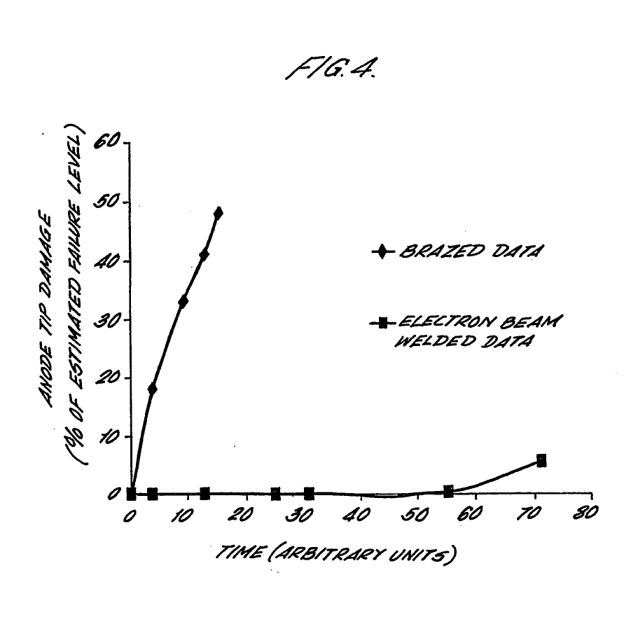

FIG. 4 is a graph showing a comparison between the performance of an anode tip according to the prior art, which has been joined to an electrode body by brazing, and an anode tip according to the present invention, which has been joined by electron beam welding.

With reference to FIG. 1(a), there is shown an electrode 40 for a plasma torch which comprises an electrode tip holder 41 and a stub end electrode tip 42. The body (not shown) comprises a metal housing, on to which is mounted the electrode tip holder 41. It will be appreciated that there is electrical contact between the housing, the tip holder 41 and the electrode tip 42.

The stub-ended tip 42 is in the form of a cap with a substantially planar front face 43, from where, in use, the plasma is generated. The open end of the stub-ended tip 42 has a diameter that is larger than the diameter of the end of the tip holder 41 and thus the tip 42 can be mounted thereover. The stub-ended tip 42 is joined to the tip holder 41, at the overlapping portions, by fusion welding, preferably by electron beam welding.

In use, the stub-ended tip 42 is subjected to very high temperatures and this can result in distortion of the front face 43. In particular, the front face 43 tends to bow outwardly, perhaps due to the softening of the tip material 42 (see FIG. 1(b)). It has been found that the service life of a stub-ended electrode may be predicted by assessing the distortion of the front face, which is thought to reduce the effectiveness of the cooling. Accordingly, a reduction in the distortion of the front face is a desideratum. In the present invention this is achieved, surprisingly, by joining the stub end to the electrode body/tip holder by fusion welding, preferably electron beam welding.

FIG. 2 is a cross section of an assembled anode 20 torch assembly. This is of modular construction comprising an electrode module 2, a nozzle module 3, a shroud module 4, and a electrode guide module 5. The electrode module 2 is in the interior of the torch 20. The electrode guide module 5 and the nozzle module 3 are axially spaced apart surrounded the electrode module 2 at locations along its length. At least the distal end (i.e. the end from which plasma is discharged from the torch) of the electrode module 2 is surrounded by the nozzle module 3. The proximal end of the electrode module 2 is housed in the electrode guide module 5. The nozzle module 3 is housed in the shroud module 4.

Sealing between the various modules and also the module elements is provided by “O” rings. For example, “O” rings provide seals between the nozzle module 3 and both the shroud module 4 and electrode guide module 5. “O” rings are shown as small filled circles within a chamber.

The torch 20 has ports for entry of process gas and shroud gas respectively. Entry of process gas is towards the proximal end of the torch 20. Process gas enters a passage between the electrode 2 and the nozzle 3 and travels towards the distal end of the torch 20. In this particular embodiment, shroud gas is provided at the distal end of the torch 20. This keeps shroud gas away from the electrode and is particularly advantageous when using a shroud gas which may degrade the electrode module 2, e.g. oxygen. However, in other embodiments, the shroud gas could enter towards the proximal end of the torch 20.

A specific embodiment of the construction of the electrode module 2 is shown in FIG. 3. The anode electrode module 2 of FIG. 3 typically comprises a copper or silver electrode “stub ended” tip 21 mounted onto a copper electrode tube holder 22. The tube holder 22 is mounted onto a metal housing 23.

The torch 20 may be used in a twin plasma torch assembly, in both open and confined processing zone chambers.

FIG. 4 shows a comparison between the performance of an anode electrode tip according to the present invention and one according to the prior art. It is clear that the damage to the anode tip, which occurs during use, is far less for the electron beam welded anode tip compared with the prior art brazed anode tip. It is also clear that the predicted service life for the electrode tip according to the present invention is improved significantly compared with the prior art.

1. An anode electrode for a plasma torch comprising an electrode body and an electrode tip, wherein the electrode tip is electron beam welded or laser welded either directly or indirectly to the electrode body, and wherein the electrode tip comprises a metal or alloy selected from one or both of copper and/or silver.

2. An anode electrode as claimed in claim 1 comprising a body having an electrode tip holder portion, wherein the electrode tip is welded to the electrode tip holder portion.

3. An anode electrode as claimed in claim 2, wherein the body comprises a metal housing and wherein the electrode tip holder portion is mounted on the metal housing.

4. An anode electrode as claimed in any one of the preceding claims, wherein the electrode tip is a stub-ended tip.

5. A plasma torch having an anode electrode as defined in any one of claims 1 to 4.

6. A plasma twin torch assembly comprising an anode electrode as defined in any one of claims 1 to 4 and a cathode electrode.

7. A process for the manufacture of an anode electrode for a plasma torch comprising an electrode body and an electrode tip comprising a metal or alloy selected from one or both of copper and/or silver, which process comprises the step of electron beam welding or laser welding the electrode tip, either directly or indirectly, to the electrode body.

8. A process as claimed in claim 7, wherein the electrode comprises a body having an electrode tip holder portion, and wherein the electrode tip is welded to the electrode tip holder portion.

9. A process as claimed in claim 8, wherein the body comprises a metal housing and wherein the electrode tip holder portion is mounted on the metal housing.

10. A process as claimed in any one of claims 7 to 9, wherein the electrode tip is a stub-ended tip.

11. A process as claimed in any one of claims 7 to 10, wherein the step of welding is performed in vacuo.

12. A method of improving the service life of an anode electrode for a plasma torch, the electrode comprising an electrode body and an electrode tip comprising a metal or alloy selected from one or both of copper and/or silver, which method comprises joining, either directly or indirectly, the electrode tip to the electrode body by electron beam welding.

13. A method as claimed in claim 12, wherein the electrode tip is a stub-ended tip.
